(19) United States
(12) Patent Application Publication
(10) Pub. No.: US 2010/0087182 A1
(43) Pub. Date: Apr. 8, 2010

(54) SYSTEM AND METHOD FOR CALLING PARTY TO SPECIFY A RING TONE USED BY A CALLED PARTY'S MOBILE PHONE

(76) Inventors: Robert J. Stewart, Soquel, CA (US); Richard Anthony Mizer, San Francisco, CA (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(21) Appl. No.: 12/618,655

(22) Filed: Nov. 13, 2009

Related U.S. Application Data
(63) Continuation-in-part of application No. 12/431,666, filed on Apr. 28, 2009.
Application No. 12/431,666 is a continuation-in-part of application No. PCT/US07/82076, filed on Oct. 22, 2007.
Application No. 12/431,666 is a continuation-in-part of application No. PCT/US07/84711, filed on Nov. 14, 2007.
(60) Provisional application No. 60/855,845, filed on Nov. 2, 2006.
(60) Provisional application No. 60/928,986, filed on May 14, 2007.
(60) Provisional application No. 60/928,986, filed on May 14, 2007.

(51) Int. Cl. H04M 3/00; H04W 4/00

(52) U.S. Cl. 455/419; 455/466

(57) ABSTRACT

A calling party is permitted to determine a ring tone to be played by a called party's mobile phone. Upon receiving an indication of the called party telephone number and a ring tone to be pushed to the called party's handset, the calling party is placed on hold on a conference bridge. The subject ring tone and a designated ANI are transmitted to the called party's handset. Thereafter, an outbound call is placed to the called party's handset such that a ringing signal transmitted to the called party's handset includes the designated ANI. When a connection is established with the called party's handset, the outbound call is bridged with the calling party's call on the conference bridge. Alternatively, in some instances, calls may be place directly from the calling party to the called party along with an indication of a ring tone to be played.

### RELATED APPLICATIONS

This application is a Continuation-in-Part of:
(a) U.S. patent application Ser. No. 12/431,666, filed 28 Apr. 2009, which is a Continuation-in-Part under 35 USC 111(a) of International Applications PCT/U.S.07/82076, filed 22 Oct. 2007, which claims priority to and incorporates by reference U.S. Provisional Patent Application Nos. 60/855,845, filed 2 Nov. 2006 and 60/928,986, filed 14 May 2007, and PCT/U.S.07/84711, filed 14 Nov. 2007, which claims priority to and incorporates by reference U.S. Provisional Patent Application No. 60/928,986, filed 14 May 2007; and
(b) under 35 USC 111(a), of International Application PCT/U.S.07/84711, filed 14 Nov. 2007, which claims priority to and incorporates by reference U.S.

Provisional Patent Application No. 60/928,986, filed 14 May 2007, all of which are assigned to the assignee of the present invention and incorporated herein by reference.

### FIELD OF THE INVENTION

The present invention relates to telecommunications systems and, more specifically, to methods and systems for a calling party to specify and/or control, for example on a per-call basis, a ring tone to be played by a mobile phone (or similar device) of a called party.

### BACKGROUND

A ring tone (or ringtone (herein the bifurcated form of this term will be used)) is the sound made by a telephone to alert a called party to an incoming call. The term is most often associated with customizable sounds available on mobile phones that allow users to distinguish the ringing sound made by their own phones from those made by phones of others. Thus, a ring tone is distinguished from a ringing signal, which in the case of a mobile phone is a radio-frequency signal transmitted to a mobile phone handset over a call control channel. Upon receipt of a ringing signal, a mobile phone will play a ring tone (provided the mobile phone's ringer is not muted or otherwise disabled).

In recent years, mobile phone ring tones have become quite popular and entire businesses are now devoted to producing and selling such ring tones to mobile phone users. It is very common for mobile phone users to change their ring tones frequently and/or to assign unique ring tones to different callers. This individual association of a ring tone to one or more unique callers relies on the use of calling party information that is transmitted to the mobile phone prior to call establishment and information previously stored on the subject mobile phone. By comparing the calling party's ANI with stored records of phone numbers, the mobile phone is able to determine, and subsequently play, the associated ring tone for that calling party. Note, this process requires that the owner/user of the subject mobile phone handset program the mobile phone with sufficient information to identify the calling party's ANI and with an associated ring tone. It is also indeterminable from the calling party's point of view in that the calling party cannot control or influence the ring tone to be played by the called party's mobile phone handset.

### SUMMARY OF THE INVENTION

In one embodiment of the present invention, a calling party provides a called party telephone number and a ring tone to be pushed to that telephone number. The calling party is placed on hold on a conference bridge and the ring tone and an ANI are transmitted to the called party's telephone number in a format suitable for use by a mobile phone handset associated with the called party telephone number. Thereafter, an outbound call is placed to the called party's telephone number such that a ringing signal transmitted to the called party's telephone number includes the ANI. This causes the called party's mobile phone handset to play the pushed ring tone. Upon establishing a connection with the called party's telephone number, the outbound call is bridged with the call from the calling party on the conference bridge.

In a further embodiment of the invention, in response to receipt of a called party's telephone number and identification of a ring tone to be pushed to a mobile phone handset associated with the called party telephone number, the ring tone and an ANI to be associated therewith are transmitted to the called party telephone number in a format suitable for use by the mobile phone handset associated with the called party's telephone number. The ring tone is preferably one that is selected by a calling party, who may also select the date and time that it is to be pushed to the called party, and the ANI to be associated with the ring tone is then an ANI associated with a mobile phone of the calling party. The calling party may instruct that the ring tone be pushed, simultaneously or nearly so, to multiple different mobile phone handsets, for example for use as part of a conference call or by a group of friends, etc.

Prior to pushing the ring tone to the mobile phone handset associated with the called party's telephone number, an operating system-level application is installed on the mobile phone handset associated with the called party's telephone number. The application permits association of a push ring tone with a calling party's ANI (or other trigger). Once such an application and an associated ring tone have been installed on the mobile phone handset associated with the called party's telephone number, subsequent calls from the calling party's handset (which is associated with the ANI) may be placed directly to the mobile phone handset associated with the called party's telephone number so as to trigger, based on the ANI, playing of the ring tone.

The application may be downloaded by the called party in response to an invitation, e.g., sent via a text message, to receive same. The called party can accept the invitation either by sending a response message or by calling an automated service. Alternatively, the application may be pushed at the same time as the ring tone and the calling party invited to accept same through a prompt on the called party's handset. In still other instances, the application may be installed on a SIM card used by the called party's mobile phone handset and executed from the SIM card or installed into memory on the handset and executed from memory.

These and further embodiments of the invention are described in greater detail below.

### BRIEF DESCRIPTION OF THE DRAWINGS

The present invention is illustrated by way of example, and not limitation, in the figures of the accompanying drawings in which:

FIG. 1 illustrates an example of a network architecture within which embodiments of the present invention are implemented; and

FIG. 2 is a flow diagram illustrating one example of a call flow for pushing ring tones in accordance with embodiments of the present invention.

FIG. 3 is a flow diagram illustrating a further embodiment of the invention in which a called party's mobile phone is provisioned for playing a pushed ring tone prior to a call from a calling party.

FIG. 4 is a flow diagram illustrating yet another embodiment of the present invention in which a called party's mobile phone is provisioned to play a designated ring tone (or voice message) in response to receipt of a USSD message.

### DETAILED DESCRIPTION

Embodiments of the present invention are directed to telecommunication systems and methods for allowing a calling party to specify a ring tone to be played by a called party's mobile phone handset (or similar device, e.g., a personal digital assistant that includes mobile phone capability). Such ring tones are not necessarily limited to tones, but may also include music and/or recorded voice files. Thus, even if the called party already has programmed a distinctive ring tone for his/her mobile phone, including a unique ring tone associated with the specific calling party, the present invention enables the calling party to override or “trump” that currently programmed ring tone of the called party's mobile phone and have a calling party-specified ring tone played on that device to announce the call by the calling party. These “trump” ring tones will sometimes be referred to herein as “push ring tones”.

In one example of an implementation of the present invention, the calling party is permitted to specify the ring tone to be played by the called party's mobile phone handset as part of the call process. In this instance, the calling party makes use of a service that pushes the ring tone to the called party's phone at the time of the call. The calling party accesses the service by placing a call to a platform operated by the service provider and thereafter interacting with an automated prompt and response system. As part of this interaction, the calling party is permitted to specify the telephone number of the called party's mobile phone handset and a ring tone to be played by that handset. Upon receiving these instructions, the service places the calling party on hold on a conference bridge and transmits the subject ring tone and a designated ANI to the called party's handset. Thereafter, the service places an outbound call to the called party's handset such that a ringing signal transmitted to the called party's handset includes the designated ANI. When the called party's handset recognizes this designated ANI, the pushed ring tone is played. Thereafter, when the called party answers the call, the outbound call from the service is bridged with the calling party's original call on the conference bridge.

In a further example of an implementation of the present invention, the called party's mobile phone is provisioned in advance of a call from a calling party. That is, the designated ring tone to be played upon receipt of a call by the calling party, along with an operating system-level application which will permit playing of the designated ring tone in response to receipt of a call from the calling party are installed on the called party's mobile phone at some time prior to the calling party placing a call to the called party. This allows the calling party to call the called party's mobile phone directly, without having to invoke the use of the above-described service at the time of the call, and still have the called party's mobile phone announce the call using a ring tone specified by the calling party.

The provisioning of the called party's mobile phone may involve the calling party providing (e.g., to a service similar to that discussed above and accessed either by phone or, in some cases, by a Web browser running on a computer system or a mobile device) the telephone number associated with the called party's mobile phone handset and an indication of a ring tone to be played by that mobile phone handset in response to receipt of a ringing signal indicating a call from the calling party. Of course, to associate the ring tone with a call from the calling party, the calling party's ANI may also need to be provided. This information can be specified by the calling party as part of the provisioning process or it can be obtained automatically by the service in the case where the provisioning is performed by the calling party placing a call to a platform operated by the service provider. In other cases, as discussed below, instead of using the calling party's ANI, the called party's mobile phone may be provisioned to play the designated ring tone in response to receipt of an Unstructured Supplementary Service Data (USSD) message.

Once the calling party has specified the called party's number and the desired ring tone, the service may push (subject to the called party's consent) the operating system-level application (or script) to the called party's mobile phone. As indicated above, once installed, this set of instructions will configure the called party's mobile phone to play the designated ring tone when it receives a ringing signal indicating an inbound call from the calling party (e.g., a ringing signal including the ANI of the calling party) or a USSD (or other) message accompanying such a call. The application, or data associated with the application, may therefore include the specified ring tone and the ANI of the calling party, or another trigger key that might be used in conjunction with a USSD (or other) message.

In still another example of an implementation of the present invention, a calling party and one or more potential called parties may become members of a “fling tone club” or association or, more generally, a “user base” (i.e., a collection of users that have agreed to permit calling parties to push ring tones to their mobile phones). User bases may be associated with particular telecommunications carriers, social network providers, or other organizations. An individual may be associated with more than one user base and, hence, may permit different groups of calling parties to push similar or different ring tones to his/her mobile phone.

As members of a user base, individuals would be entitled to download an operating system-level application from a service provider's Web site or other platform (e.g., a platform designed for use with mobile phones and configured to provide mobile phone applications via enhanced message service (EMS) or other means) and install same on their mobile phones. The application configures a party's mobile phone operating system in such a way that ring tones selected by a calling party can be triggered upon recognition of an ANI of a calling party or a USSD message. The ring tones may have been previously stored on the called party's mobile phone handset or may be delivered to the called party's handset via an EMS download in advance of a call, or, alternatively, concurrently with a call, depending on the bandwidth of the service provider's network and preferences of the calling and/or called party.

In embodiments that make use of a USSD message to trigger the playing of a designated ring tone, the USSD message may be sent concurrently with a call or by itself without any concurrent call. The designated ring tone may be pre-recorded ring tone or a voice message stored on the called party's mobile phone handset, but the playing of the ring tone or voice message need not be accompanied by an incoming phone call. For example, the platform initiating the USSD message can be programmed to send the USSD message at a designated time. In this manner, for example, a ring tone or voice message intended as a greeting or announcement may be designated to be sent to a called party's mobile phone handset at a designated day/time. This may be regarded as a form of time shifting the playing of a ring tone or other message and the time-shifted ring tone/message played on the called party's mobile phone handset need not be tied to an incoming call. Instead, the ring tone/message would be played at a designated time (in response to receipt of a USSD message) specified by an initiator (e.g., a friend of the party on whose handset the ring tone is played, a network operator, a political candidate, etc.).

In various embodiments of the invention then, in order to facilitate the association of a calling party's. ANI (or another form of triggering indicator used with a USSD or similar message) with a specific push ring tone on a called party's mobile phone, an operating system-level application is downloaded to the called party's mobile phone prior to call initiation. As indicated above, this download and installation may be made when the called party joins a particular user base. Or, for example, a company may have such an application installed on mobile phones used by its employees so that company-specific ring tones may be pushed to the phones by a company's information services department or employees of the company.

The downloaded operating system-level application permits a calling party's ANI (or USSD message trigger) to be associated with a push ring tone (e.g., as an entry in a table or other data structure included as part of the application). This may be a push ring tone previously stored on the called party's mobile phone handset or a new push ring tone provided via EMS message. The push ring tone is transmitted to the called party's handset (or recalled from memory if previously stored on the called party's handset) and temporarily overrides the called party's pre-set ring tone when the associated calling party's ANI is recognized as part of a ringing signal (or a trigger is recognized in a received USSD message, which trigger may, but need not, include the ANI of the calling party). In addition to the downloaded application, the push ring tone selected by the calling party is preferably received and stored at the called party's mobile phone prior to the calling party actually phoning the called party. This permits the calling party to directly dial the called party and have a push ring tone played at the called party's mobile phone, without the need to first contact a service provider's server as described in U.S. PGPUB 2006/0215827 of Pfleging et al. Further details of this process are described below.

To understand the need for the operating system-level application discussed above, consider that for a given mobile phone or similar device a microprocessor or similar unit acts as a central controller. This processing unit executes computer-readable instructions (which are stored in memory or other computer-readable storage media accessible by the processing unit) to carry out the operations of the mobile phone, including the playing of ring tones (typically in response to the receipt of ringing signals). More specifically, in response to the receipt of a ringing signal, a sequence of computer-readable instructions that direct the processing unit to control (directly or indirectly) the vibration of the mobile phone's speaker is executed. By controlling the oscillation of the speaker in a given pattern, different musical notes (as experienced by the user) are played. Hence, a ring tone program may be regarded as a set of instructions for which of these notes to play, in which order and at what speed. By adjusting these variables, the mobile phone's processing unit can control the playing of a virtually infinite number of ring tones. Of course, different mobile phone manufacturers use differing syntaxes for these ring tone programs, but such details are not critical for purposes of the present invention.

Ring tones (that is, ring tone programs) may be stored to a mobile phone's memory (or other computer-readable storage medium, such as a removable, solid-state storage device) in any of a variety of ways, including by downloading the ring tone over the air. That is, the short programs that make up the ring tones when the computer-readable instructions are executed by the mobile phone's processing unit may be transmitted to the mobile phone via a wireless communication channel using EMS (the multimedia message service (MMS) is one example of EMS).

Originally developed for transferring short text messages between mobile phone users, the so-called short message service (SMS) has evolved to permit the transfer of ring tone programs via both SMS (in the case of simple, e.g., monotone, ring tones) and EMS (for more complex ring tones). SMS and related messages do not travel directly between mobile phone handsets. Instead, messages transmitted by one mobile phone travel through an SMS center (SMSC) before being transmitted to the destination mobile phone. The SMS message protocol uses the same call control channel as is used by the ringing signal. Hence, the SMSC, which acts as a media gateway at the edge of the mobile phone RF network, can also be used to transfer ring tone programs to a target mobile phone. Indeed, in some embodiments the present invention makes use of such facilities to transfer calling party-specified (push) ring tones (i.e., push ring tone programs) to the called party's mobile phone. Note that while the remainder of the discussion refers to ring tones being pushed via EMS messages, the present invention is not limited to the use of EMS messages and where only simple ring tones are involved SMS messages may be used.

In one embodiment of the present invention, a calling party dials a telephone number associated with a push ring tone service. The call is answered by an automated system (which may include an interactive voice response system) that allows the calling party to specify his/her desire to push a ring tone to a called party as part of a call set up process. For example, the automated system may prompt the user to select a desired push ring tone from a menu of available choices by entering a selection via a touch tone key sequence from the calling party's mobile phone. Alternatively, or in addition, the calling party may select a desired push ring tone and/or a called party from a pre-established account.

Once a desired ring tone has been specified, the calling party is prompted to provide the mobile phone number for the called party. Note, in some cases the called party's number may be collected before the push ring tone is selected. The order of such operations is not critical to the present invention. Again, this information may be provided via a touch tone key sequence from the calling party's mobile phone or selected from a pre-established account (e.g., from an electronic address book). For example, as part of a subscription process, a user (the calling party in this example) may create an account and store multiple telephone numbers of contacts for later use. Desired push ring tones may be associated with some or all of these telephone numbers/contacts at the time the account is created, at a later time, or on-the-fly during a call establishment process.

As an aside, as part of the subscription or registration process, the above-described operating system-level application may be downloaded to the user's mobile phone. This application would then be resident on the user's mobile phone and permit association of a push ring tone with a calling party's ANI when a ringing signal is received. The details of such a program will vary according to the user's mobile phone operating system, but in general the association must be between the calling party's ANI and the specified push ring tone, which is either pushed to the called party's mobile phone via EMS or is previously stored on the called party's mobile phone as discussed above.

In addition, during the subscription/registration process, the user may specify one or more user bases which he/she wishes to join. These are groups of users that have consented to other members of the same user group pushing ring tones to their respective mobile phones. This way users can control which third parties have the ability to affect the ring tone played by their respective mobile phones. Without such control, inappropriate ring tones may be pushed to unsuspecting called parties. The user bases may be associated with existing social networks to which the users belong or they may be newly created user bases specifically for the purposes of using the push ring tones. Users may register their own mobile phone telephone numbers with the user base and may also specify which push ring tones they are willing to receive. For example, some users may prohibit push ring tones that involve inappropriate material or which are spoken voice and not prerecorded ring tones. Further, in some embodiments the users may designated times when push ring tones are acceptable and other times when they are not. For example, some users may wish to prohibit push ring tones during business hours, but permit them during other times (e.g., on weekends). Many other personal user preferences can be similarly designated as part of the subscription/registration process, as is common with other registration processes for personalized services.

Once the desired push ring tone and the called party's telephone number have been provided, the calling party's call is connected to a conference bridge and placed on hold. In parallel, the automated system may check to see whether or not the desired push ring tone is already stored on the called party's mobile phone handset. To facilitate this look up process, the automated system may keep a log of which push ring tones have already been provided to which called party numbers and/or which ring tones have been downloaded to that number (e.g., via a Web interface or over-the-air process). Such information may be stored as part of a user's individual account or as part of a user base account. Such details are not critical to the present invention. If the desired push ring tone is already stored on the called party's mobile phone handset, the automated system may proceed to place a call to the called party's number as discussed below.

If the selected push ring tone has not been previously provided to the called party's handset, the automated system transmits an EMS (or similar) message to the called party's mobile phone (i.e., the telephone number specified by the calling party) via the call control channel of the called party's mobile phone service. The EMS message includes the calling party's specified ring tone (i.e., a program that will direct the called party's mobile phone to play the specified ring tone). The push ring tone (i.e., the ring tone program) is stored to the called party's mobile phone upon receipt.

Following transmission of the EMS message containing the pushed ring tone, the automated system places an outbound call to the called party's mobile phone number. This causes a ringing signal to be transmitted to the called party's mobile phone. That ringing signal may be tagged in order to trigger playback of the pushed ring tone (i.e., execution of the pushed ring tone program by the processing unit in the called party's mobile phone).

For example, the pushed ring tone may be transmitted or downloaded to the called party's mobile phone in conjunction with an identifier (e.g., an ANI) of the automated service. Hence, when the automated service places the outbound call to the called party's mobile phone, the ringing signal transmitted to that mobile phone will include the ANI stored in conjunction with the pushed ring tone. When that ANI is recognized by the called party's mobile phone, the stored ring tone will be played.

Upon answering the call, the called party will be connected to the conference bridge where the calling party's call was parked. Thus, the two parties are connected via a voice channel and can now speak with one another. At the end of the call, a disconnect signal from one or both of the calling party's mobile phone and/or the called party's mobile phone will signal the automated system to tear down the conference bridge and terminate the call.

In the event the called party does not answer the call, the calling party may be so informed by the automated service. In such instances, the calling party may be presented with the option to leave the called party a message for later retrieval by the called party (e.g., in response to an SMS or other message advising the called party of the availability of the message and number to call to retrieve same) or to terminate the call.

As indicated above, to prevent abuse of pushed ring tones, in some embodiments of the invention a called party must “opt in” to the use of such pushed ring tones. That is, the automated system may be configured to first determine whether or not a called party has indicated his/her consent to receipt of same. This may entail a further database lookup prior to transmission of the pushed ring tone to the called party's number.

For example, upon receipt of the called party's number from the calling party, the automated system may consult a database of telephone numbers to which push ring tones may be transmitted. If the called party's number appears in that list, the push ring tone will be transmitted. If not, the calling party may be advised that the push ring tone cannot be transmitted because the called party has not consented to receipt of same. In this latter case, an SMS message may be transmitted to the called party advising of the push ring tone service and allowing the called party to opt in to subsequent receipt of push ring tones by indicating his/her consent to same.

As further indicated above, in various embodiments of the present invention, the automated service described above may be associated with a social network system. Users participating in the social network system may opt in to the push ring tone service. As part of such a subscription, users may be asked to identify their individual mobile phone service and/or individual mobile phone handset type so that the push ring tone service can select and use appropriate ring tone programs for the service/handset.

In some cases, the push ring tone program may be fashioned from a recording of the calling party's voice. For example, during the call process instead of selecting an existing ring tone as the push ring tone the calling party may opt to use a voice ring tone. In such cases, the calling party is prompted to record a short (e.g., a few seconds) voice message, which the automated service will transform into a ring tone program. Services for transforming music and/or voice files to ring tones are already well know in the art and so will not be described further herein. Once the voice ring tone is ready, it is pushed to the called party's phone in the manner discussed above and played out as a ring tone upon receipt of the outbound call from the automated service. In some cases, this may obviate the need for a longer call where the calling party simply wants to transmit a brief message to the called party. In light of such capabilities, premium service rates may apply for the use of such pushed voice message ring tones.

Subscription to the social network discussed above may be offered as a stand-alone service or integrated with other calling plan packages by a mobile phone service provider. Social networks may be defined by service provider, mobile phone brand/model and/or mobile phone network communication protocol. Moreover, the social network and/or the automated system may be made accessible via the Internet so that users can customize their individual accounts. For example, a user may configure a personal address book and associate one or more contacts with ring tones and or voice messages to later be pushed to called parties via a personal computer communicatively coupled (e.g., via the Internet) to a host platform operated by the push ring tone service provider. This host platform may be accessed by the automated service that responds to calling party calls as discussed above, or it may be periodically replicated on other platforms accessible by same.

Alternatively, or in addition, to the above-described methods, social networks may be formed on an ad-hoc basis between two or more users becoming “flingtone partners”. Such a partnership may be established between users that have each downloaded and installed mobile phone applications such as those described herein (e.g., from a service provider's application store or an application store operated by a third party and accessible via a user's mobile phone). Willing partners may be discovered through a discovery process accessible via the application, for example by advertising the user as being willing to accept flingtone partners or by sending invitations to the user's contacts, etc.

Regardless of how they are formed, social network “clubs” may be established with rules for pushing ring tones from one member to another. Individuals may create unique ring tones for the club and limit enrollment in the club to specified invitees. Invited members may subscribe to the club ring tone(s) and/or select their own ring tones to use when calling other members of the club. Clubs may be formed by any group(s) of individuals and may be based on any common attribute or shared interest of the members of the group(s).

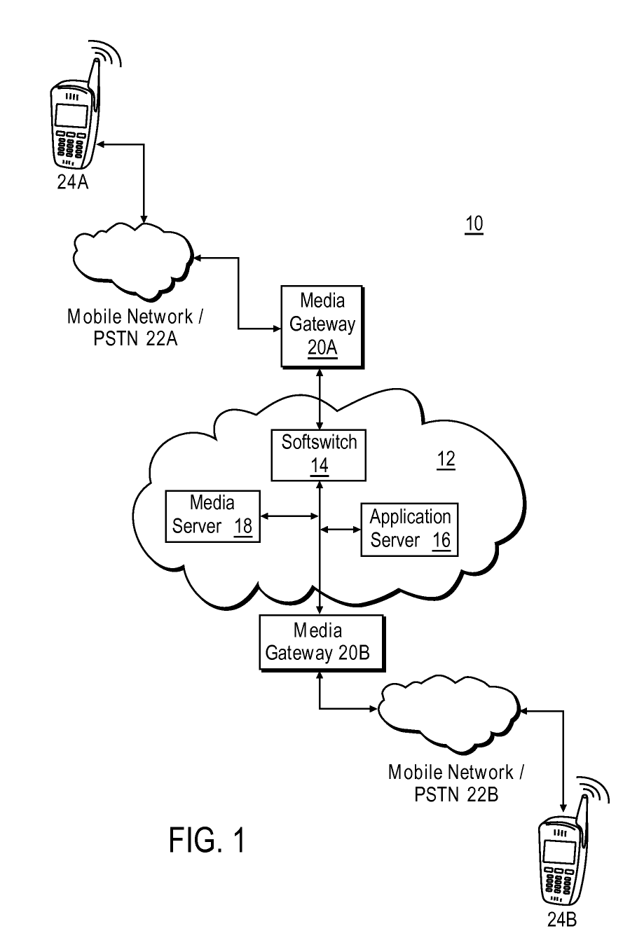

One example of a network architecture for implementing embodiments of the present invention is shown in FIG. 1. System 10 includes an Internet protocol (IP) network 12 wherein a softswitch 14 resides. The IP network may be the Internet or may be a private network. In some cases, IP network 12 will be a private network communicatively coupled to the Internet and accessible there through. Softswitch 14 is communicatively coupled to one or more application servers 16 and to one or more media servers 18. Note, in some embodiments, one or more of these functions may be combined in a single server/softswitch, but are shown here as separate functional units for ease of description. Likewise, although not shown in the illustration, a separate server may be used for caller authentication/verification purposes. Alternatively, caller authentication/verification functions may be performed by the softswitch 14 and/or an application server 16.

Softswitch 14 is also communicatively coupled to media gateways 20a and 20b. These media gateways act as call termination points for calls made via mobile networks/PSTNs 22a and 22b, respectively. In practice there hill be segregations between the mobile phone networks and PSTNs, however, for purposes of the present invention these distinctions are not critical. Hence, the details of each network are not illustrated and the multiple networks may be treated as a single network for the present purposes. In some cases, the different mobile networks/PSTNs and media gateways will be located in the same calling area. Often, however, the respective pairs of PSTNs and media gateways will be located in different calling areas. Communicatively coupled to the mobile networks/PSTNs 22a and 22b are mobile phones 24a and 24b, respectively.

In operation, a calling party may place a call from mobile phone 24a to a telephone number associated with a port on media gateway 20a. The call is transported via mobile network/PSTN 22a and terminated on media gateway 22a. As further discussed below, the number dialed by the calling party is associated with the push ring tone service. Hence, following optional user authentication (which may involve requesting and verifying a user's account number or other identifying information to allow for debiting of the user's prepaid account) and/or verification (e.g., which may involve assessing a current state of the user's account) the associated service is provisioned by softswitch 14 when the call is recognized as having been received on the port of media gateway 20a that is associated with the telephone number of the push ring tone service. Provisioning the call may require the softswitch to launch an application hosted at application server 16 and/or providing media from media server 18. For example, the softswitch 14 may connect the call with a push ring tone application running on application server 16.

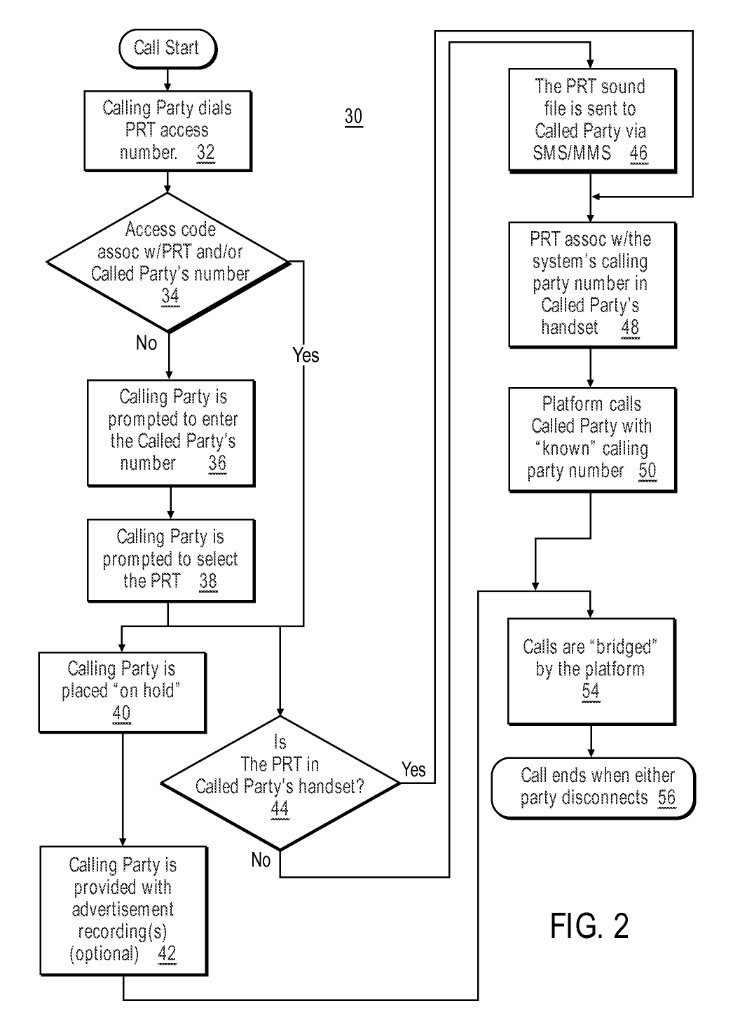

Further details of the call process are illustrated by process 30, shown in the flow diagram of FIG. 2. Initially, at step 32, the calling party's call is placed to the automated service associated with the push ring tone (PRT) facilities. This may be a toll free number or a local access (e.g., DID or DDI) number. Separate access numbers may be provided for separate user bases (e.g., pre-determined group of users who have agreed to allow each other to send pre-approved PRTs to each other's phones). Alternatively, a single access number may be used for all user bases and unique user base pass codes assigned for use at the time a calling party places a call (e.g., to identify an individual user base through a data base look-up). Or, the proper user base may be identified through an ANI identification and/or previously provided personal identification number.

Upon receipt of the calling party's call and (optionally) entry of an access code or receipt of other identifying information, the softswitch 14 determines whether the calling party's number is already associated with a called party's telephone number and a particular push ring tone (step 34). This may involve the calling party entering personal identification information to access his/her previously established account or the calling party providing credit card or other payment information for a one-time use, etc. If the calling party is not authorized to use the service, the call may be terminated.

Assuming the calling party is authorized to use the service, the Calling party is connected to the appropriate application and is prompted to either select an existing called party's record (e.g., a phone number previously associated with a selected push ring tone) or enter the called party identification information (step 36) and to select a push ring tone (or record a voice ring tone) (step 38).

As shown in the illustration, if the called party is already associated with a push ring tone (step 34), the call process skips to placing the calling party on hold on the conference bridge (step 40). Otherwise, the calling party interacts with the automated service as discussed above to select a ring tone to be pushed to the called party. Optionally, the service may check to determine whether the called party has opted in to receiving such push ring tones. If not, the call is terminated. Otherwise, the call proceeds and the calling party is placed on hold on the conference bridge. While on hold, advertisements or other messages may be played to the calling party (step 42).

While the calling party is on hold, the automated service proceeds to determine whether or not the selected push ring tone is already stored on the calling party's handset (step 44). This may involve a data base look up to determine what ring tones have already been pushed to the called party and which ring tones the called party may have already downloaded. Such information may be associated with the called party's account or user base records.

If the selected push ring tone has already been stored to the called party's mobile phone handset, the service proceeds to place a call to the called party as discussed below. Otherwise, the service transmit the push ring tone to the called party as discussed above (step 46). This may involve the softswitch 14 transmitting an EMS message (e.g., encapsulated as an IP message for transport across the IP network 12) to media gateway 20b associated with an outbound PSTN/mobile network 22b. At the media gateway 20b, the EMS message is extracted from the IP message and transmitted to the called party's mobile phone 24b using PSTN/mobile network 22b. The softswitch 14 would have already formatted the EMS message to be compatible with that service provider's network and with the called party's mobile phone (e.g., as identified when the called party was verified as having opted in to receive push ring tones).

After allowing sufficient time for the called party's mobile phone to receive and store the push ring tone (step 48), during which time the push ring tone is associated with the ANI that will be used to place the call to the called party's handset, the softswitch 14 places an outbound call to the called party (step 50). This is an IP-to-PSTN call and the manner of making such calls is well known in the art. Importantly, the call is placed using an ANI with a number associated with the now stored push ring tone. Upon answer by the called party, the calls are bridged (step 52) and the telephone call between the parties proceeds until one or the other ends the call (step 54) and the call is finally terminated.

In other embodiments, the calling party (and/or the system) may designate a time of day and/or a date for the ring tone to be pushed to the called party's phone (and acceptable times for same may be designated by the called party as part of a profile). This may allow the calling/called party and/or the system to conserve bandwidth during peak use times. Further, the calling Party may, in some cases, designate more than one called party to receive the push ring tone and/or a subsequent call. Thus, a personalized ring tone for a group of friends or a specific conference call may be pushed to all of the friends/conference participants. Of course, the different friends/participants may each receive unique push ring tones instead of the same ring tone.

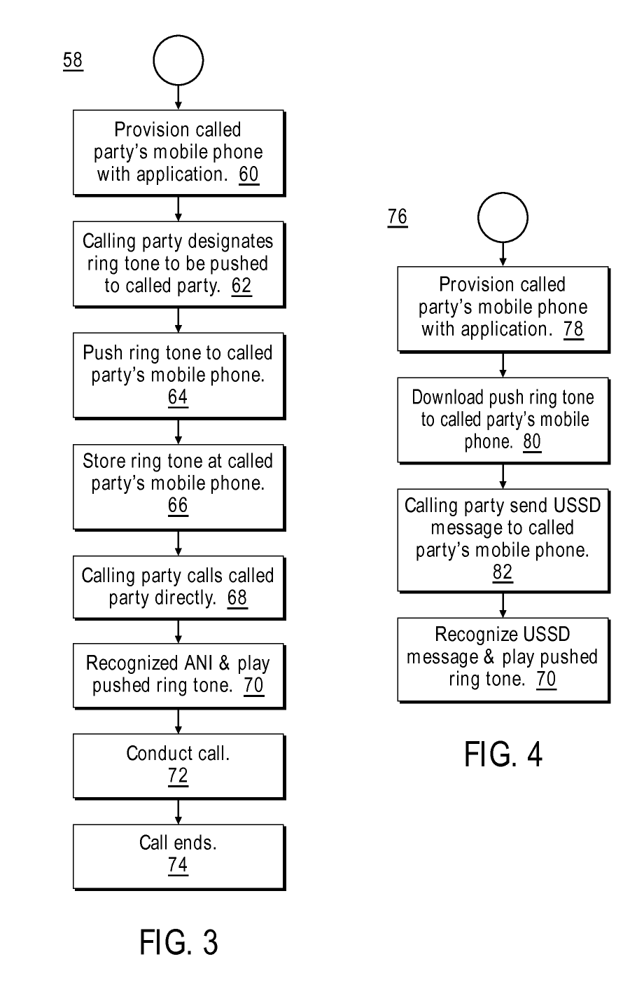

Referring now to FIG. 3, a flow diagram showing a further embodiment of the invention is provided. In this illustrated process 58, a called party's mobile phone is provisioned 60 in advance of a call from a calling party. This provisioning may involve a designated ring tone to be played upon receipt of a call by a calling party's along with an operating system-level application which will permit playing of the designated ring tone in response to receipt of a call from the calling party being installed on the called party's mobile phone at some time prior to the calling party placing a call to the called party. The provisioning may be carried out in the manner described above, where the operating system-level application and the designated ring tone are pushed from a platform such as application server 16 and/or media server 18 in response to some action initiated by a calling party (e.g., as part of a calling party establishing his/her account). Alternatively, the provisioning may be established in response to the called party downloading and installing the operating system-level application (e.g., as part of the process of establishing an account with a provider that offers the push ring tone service or in response to a request to do so initiated by the calling party at some time prior to a call). In the former case, both the application and the push ring tone may be installed on the called party's mobile phone at or about the same time, while in the latter case, the push ring tone may be downloaded sometime after the operating system-level application is installed, in response to a designation of the ring tone by the calling party.

For example, as shown in the illustration, once the operating system-level application has been installed on the called party's mobile phone as part of the provisioning step, the calling party may access a Web server operated by the push ring tone service provider (or another third party) and designate one or more ring tones (and/or record one or more voice messages) to be pushed to the called party's mobile phone 62. In so doing, the calling party may designate one or more ANIs (or other information that is included as part of a call detail record) to be associated with the push ring tones. These may correspond to telephone numbers associated with telephones likely to be used by the calling party to call the called party. Alternatively, the ANI information may be extracted automatically, for example where the called party accesses the service provider's server (e.g., application server 16) via a call from a mobile or other phone.

The ring tones (and/or voice messages), once selected and associated with the ANI or other information of the calling party may then be pushed to the called party's mobile phone 64. This may be done via EMS message(s) through a gateway (e.g., such as media gateway 20b). At the called party's mobile phone, the ring tones are stored by the operating system-level application along with the calling party's ANI or other identifier 66. This way, when a ringing signal is received, the called party's mobile phone can check to determine whether the ANI or other information included in the ringing signal is associated with a push ring tone, and, if so, play the appropriate push ring tone instead of another ring tone. This is shown in the illustration where, at 68, the called party calls the called party directly (i.e., not through a platform as discussed above), and the called party's mobile phone plays the corresponding push ring tone 70 in response to recognizing the ANI of the calling party. Thereafter, the call can proceed 72, until it is terminated by the parties 74. This embodiment of the invention thus allows a calling party to call a called party's mobile phone directly, without having to invoke the use of the above-described service at the time of the call, and still have the called party's mobile phone announce the call using a ring tone specified by the calling party.

In other instances, the calling party may be invited to download the appropriate operating system-level application via a text message (e.g., an SMS or similar message) sent to the called party's phone. The text message may be sent at the direction of a calling party (at any time, i.e., not necessarily concomitantly with a call being placed to the called party, although this is an example of when such a message may be sent) or may be sent by a service provider (e.g., as part of a promotion). The text message may describe the invitation or opportunity to download the application and allow the recipient to initiate the download of same by sending a reply message or placing a call to a designated number (e.g., a number associated with an automated voice response system that instructs the user how to download the application). Acceptance of the invitation (in whatever form) or interaction with an automated system then triggers the download and installation of the application onto the called party's phone. Or, in some cases, may trigger the download of further instructions as to how to obtain the application for download and installation on the phone. For example, some implementations may require that the application be obtained from a designated source, such as an app store or similar outlet. Or, the user may be required to agree to changes to his/her subscription agreement before being permitted to download the application. In still further embodiments, the instructions for downloading the application and/or agreeing to the terms and conditions associated with the use of the push ring tone service and/or the application itself may be included on a custom subscriber identity module (SIM) card, which a user can purchase. In such cases, users may initiate the service by agreeing to the terms and conditions and/or downloading, installing or otherwise activating the application from the SIM card.

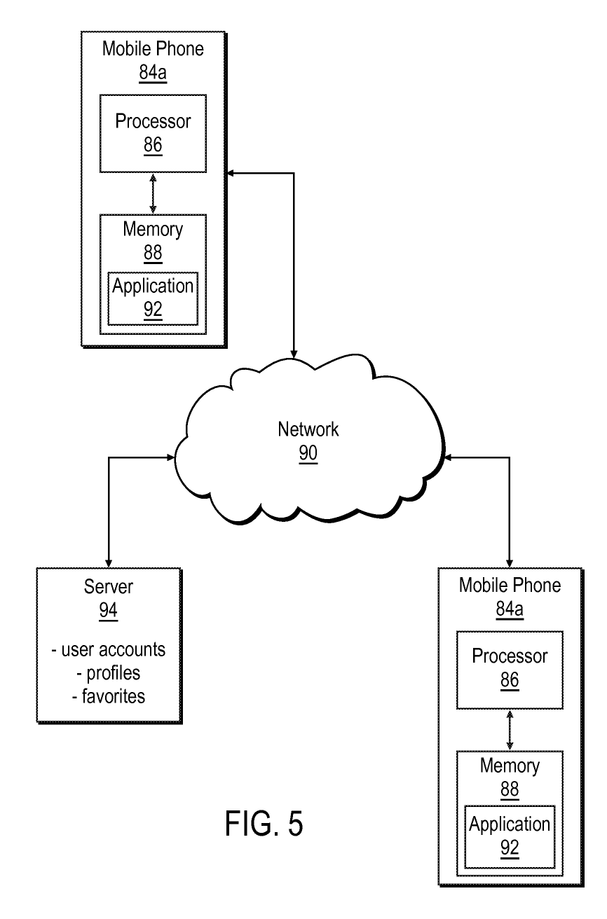

In some cases, instead of using the calling party's ANI, the called party's mobile phone may be provisioned to play a designated ring tone (or voice message) in response to receipt of a USSD message. An example of this process, 76, is shown in FIG. 4. As before, the called party's mobile phone is provisioned with the appropriate operating system-level application 78. This may be done in any of the manners previously described. Likewise, push ring downs are downloaded to the called party's mobile phone using any of the above-described processes 80. This time, the application associates the push ring tone with an identifier (which could but need not be the ANI of the calling party) that will be received as part of a USSD message.

Sometime thereafter, the calling party sends a USSD message to the called party via a USSD gateway 82. The message may be transmitted from the USSD gateway in response to any of a variety of events. For example, the calling party may call a platform such as that described above, which platform in turn may send the USSD message to the called party's mobile phone when the calling party indicates the number being called (and the remainder of the call process may resemble that discussed above with reference to FIG. 3). Or, the calling party may send an SMS message, USSD message, email or other message to the USSD gateway (or a server controlling the actions of such a gateway), and a USSD message transmitted from the USSD gateway to the called party's mobile phone. USSD gateways may be included as part of one or more media gateways 20a, 20b, or may be standalone gateways.

Alternatively, the USSD message may be sent to the called party's mobile phone in response to the calling party establishing a date and time for such a message to be sent (e.g., by specifying same at a server operated by a service provider). This can be used in situations where the ring tone or message is to be played without any contemporaneous call from the calling party. Still further, the USSD message can be used in place of the ringing signal for triggering the playing of the pushed ring tone in any of the above-discussed scenarios. The USSD message may include instructions concerning the date/time that the selected ring tone is to be played by the called party's mobile phone.

In response to receipt of the USSD message, the called party's phone plays the corresponding ring tone 84. If the USSD message is accompanied by a contemporaneous call from the calling party, the call may be conducted in the manner discussed above. Otherwise, if there is no contemporaneous call, no further activities take place. In some instances, such as when there is no contemporaneous call to the called party, a second USSD message may be sent to a calling party's mobile phone contemporaneously with the sending of a USSD message to the called party's mobile phone. This way, even though the calling party is not telephoning the called party, the calling party can be alerted that the USSD message was sent to the called party. Further, a “multicast” approach may be used where a common USSD Message is sent to multiple called parties for playing of ring tones or voice messages at substantially the same time.

In some instances, all future ring tones received by the called party from the calling party may make use of a selected push ring tone until the calling party changes same, but only so long as the calling party makes use of the automated service discussed above. Direct handset-to-handset calls that are not initiated via the automated service will not trigger the playback of the push ring tone because the ANI of the calling party will not be one associated with that push ring tone.

Alternatively, when the automated service pushes the ring tone to called party's handset, the service may associate the push ring tone with the calling party's ANI and so future handset-to-handset calls would trigger the playing of the previously pushed ring tone. As indicated above, it may be preferable to restrict the pushing of ring tones to only those mobile phones previously indicated as willing to accept same. This prevents socially unacceptable, unethical, inappropriate, or otherwise undesirable content being received by a called party.

Further still, variants of the invention may provide for installing an operating system-level application on the calling party's mobile phone, which application, when initiated, may identify (in response to user selection, for example,) whether or not calls to a particular called party's mobile phone should initiate pushed ring tones in the called party's mobile phone. Such pushed ring tones may be sent to the called party's mobile pone via EMS message or other message, and may be initiated by receipt of a USSD message from a USSD gateway. As indicated above, the EMS message and/or USSD message need not be accompanied by a contemporaneous call from the calling party's phone. If a high speed network is available to both parties (the calling party and the called party), an EMS message containing a new ring tone, or audible message, as well as a USSD message specifying that the called party's mobile phone should play this new ring tone, or audible message, may be sent concurrently with the actual call from the calling party.

In still another embodiment of the present invention, a calling party provides a called party telephone number and a ring tone to be pushed to that telephone number. The calling party is placed on hold on a conference bridge and the ring tone and an ANI are transmitted to the called party's telephone number in a format suitable for use by a mobile phone handset associated with the called party telephone number. Thereafter, an outbound call is placed to the called party's telephone number such that a ringing signal transmitted to the called party's telephone number includes the ANI. This causes the called party's mobile phone handset to play the pushed ring tone. Upon establishing a connection with the called party's telephone number, the outbound call is bridged with the call from the calling party on the conference bridge.

A further embodiment of the present invention provides a method in which an operating system-level application, which in response to triggering information, causes a specified ring tone to be played by the called party's mobile phone is provided from a first platform to a called party's mobile phone. Thereafter, the specified ring tone is provided from a second platform to the called party's mobile phone (the first and second platforms may, but need not be, the same platform). A calling party may the place a call to the called party's mobile phone, and the call may have associated therewith the triggering information. In response to receipt of the triggering information at the called party's mobile phone, the specified ring tone is played. Note that the ring tone may be a recorded voice message and in this discussion the term ring tone should be read as including such a voice message.

The triggering information may include an ANI of the calling party's telephone, or may include other information included in a call record from a call initiated by the calling party's telephone. Alternatively, the triggering information may be an Unstructured Supplementary Service Data (USSD) message.

The first platform may be a server operative to provide the operating system-level application to the called party's mobile phone in response to a request presented by the calling party. The specified ring tone may be provided to the called party's mobile phone via an enhanced message service (EMS) message or other form of message, or may be downloaded by the called party in response to receipt of such a message inviting such action.

The triggering information may be provided by the calling party while the calling party is communicatively connected to the second platform via a telephone call. Alternatively, the information may be provided as part of a session with a web server or other platform. In some cases, the calling party places the call to the called party's mobile phone via the second platform, which then contacts the called party's mobile phone through a media gateway using, at least in part, the triggering information.

At the second platform, the selected ring tone may be selected from a catalog of ring tones by the calling party. The selected ring tone may then associated with the calling party's telephone number prior to the call to the called party's mobile phone. This way, the ANI of the calling party can serve as the triggering information. Further, the call to the called party is preferably placed after a time sufficient for the selected ring tone to be stored by the called party's mobile phone.

Another embodiment of the invention involves receiving an indication of a called party to which a call is to be placed, for example, from information provided by a calling party, and then determining whether or not a ring tone associated with the call is already stored on a handset to which the call is to be placed. If so, the call is placed to the handset using an ANI associated with the stored ring tone, otherwise, the ring tone is transmitted to a mobile phone telephone number associated with the handset and the call to the mobile phone telephone number placed after a time period sufficient to allow the ring tone to be stored by the handset using the ANI associated with the ring tone. In some instances, the calling party identifies the called party by providing the mobile phone number during a call to an automated service and further selects the ring tone during the call to the automated service.

Yet a further embodiment of the invention provides a SIM card for use by a handset, such as mobile phone handset 24a or 24b. The SIM card may include the operating-system level application that will permit playing of a designated ring tone in response to receipt of a call from a calling party. The application, which is instantiated as a sequence or sequences of computer-executable instructions stored on computer readable media comprising the SIM card, may be executed from the SIM card or installed as resident in memory on the mobile phone handset from the SIM card and executed from that memory and configures the mobile phone operating system in such a way that ring tones selected by a calling party can be triggered upon recognition of an ANI of a calling party or a USSD message. The ring tones may have been previously stored on the mobile phone handset or may be delivered to the handset via an EMS or other download in advance of a call, or, alternatively, concurrently with a call.

Still further embodiments of the invention involve playing a specified ring tone at a mobile phone of a called party in response to receipt of a USSD message, wherein the specified ring tone is selected by someone other than the called party and downloaded, in response to the selection, to the called party's mobile phone prior to receipt of the USSD message. The USSD message may indicate to the called party's mobile phone which of a plurality of previously downloaded ring tones to play, and may, but need not be, associated with a contemporaneous call from an individual that selected the specified ring tone. In some cases, the USSD message may include instructions for when the selected ring tone is to be played by the called party's mobile phone. For example, where the playing is to occur at some time after the USSD message is received.

In some instances, a second USSD message may be sent to a calling party's mobile phone (even if no contemporaneous call from the calling party takes place) at or about the same time as the USSD message is sent to the called party's mobile phone. Further, the USSD message may be transmitted to multiple called parties' mobile phones at substantially the same time.

Another embodiment of the invention involves downloading an operating system level application to a calling party's mobile phone, and responsive to initiating the application on the calling party's mobile phone, determining whether a call to a called party's mobile phone should result in a pushed ring tone being played by the called party's mobile phone. The pushed ring tone may be provided to the called party's mobile phone via an EMS message or other message and a USSD message sent to called party's mobile phone to initiate playing of the pushed ring tone. The EMS message and/or USSD message need not be related to a contemporaneous call from the calling party to the called party (but certainly can be initiated substantially contemporaneously with such a call).

Still further embodiments of the invention are discussed with reference to FIG. 5. Shown in this illustration are two mobile phones 84a and 84b. Each mobile phone includes a processor 86 and memory (which may, in some instances, be a SIM card) or other storage device 88. The phones are capable of wireless communication via one or more networks 90, and installed on each phone is an instance of the operating system-level application 92 described above. Application 92 is resident in memory 88 on each respective mobile phone 84a and 84b, and when executed configures the mobile phone in such a way that ring tones selected by a calling party can be triggered upon recognition of an ANI of a calling party or a USSD message.

Also illustrated in FIG. 5 is server 94, which is configured to allow a calling party to specify his/her desire to push a ring tone to a called party's mobile phone. For example, a user of mobile phone 84a may contact the server 94 (e.g., an interactive service running on the server or a Web application running on the server) and select a desired push ring tone from a menu of available choices or from the calling party's pre-established account. Once a desired ring tone has been specified, the server prompts the calling party to provide the mobile phone number for the called party (or, in some cases, the called party's number may be obtained before the push ring tone is selected). Again, this information may be provided via a touch tone key sequence from the calling party's mobile phone or selected from a pre-established account (e.g., from an electronic address book).

Once the specified push ring tone and the called party's mobile phone number have been obtained, the server pushes the selected ring tone along with the calling party's ANI to the called party's mobile phone 84b (if the called party's mobile phone does not already have an instance of the operating system level application 92 installed, that installation may be performed before the ring tone is pushed to mobile phone 84b), where it is saved in memory 88 or another storage location. In some instances, before actually downloading and storing the pushed ring tone, the application 92 at the called party's mobile phone 84b checks to see whether the subject ring tone is already stored on the mobile phone. If so, that previously stored copy will be used and associated with the calling party's ANI as received from server 94. Alternatively, server 94 may check to see if the called party's mobile phone has previously downloaded the subject ring tone and, if so, may simply instruct the called party's mobile phone to associate the calling party's ANI with the previously downloaded ring tone. The server may maintain or access a profile associated with the called party's mobile phone in order to make this determination.

Once the ring tone is successfully associated with the calling party's ANI on the called party's mobile phone (whether by downloading the ring tone or associating a previously downloaded ring tone with the calling party's ANI), the application 92 running on the called party's mobile phone 84a may send a notification to the calling party's mobile phone 84a that the operation was successful. This notification may be sent in the form of an SMS or other text message or may be sent using a communication protocol unique to the application 92. The message may be sent directly from mobile phone 84b to mobile phone 84a or may be sent via server 94. Regardless of how the confirmation message is sent, the confirmation is preferably displayed to the operator of mobile phone 84a in some fashion, for example via a display on mobile phone 84a or by playing a specified ring tone associated with such confirmation messages. In the event the ring tone was not successfully downloaded from the server, for example, if downloading was interrupted due to network failures, server failure or phone battery failure, the application 92 on the called party's mobile phone 84b will contact the server 94 (when network and/or power conditions are restored) and initiate a new download of the ring tone. Alternatively, such repeat attempts may be prompted by the application 92 on the calling party's mobile phone 84a if a successful completion message (or a message indicating that the called party has rejected the push ring tone) is not received within a prescribed time period. The calling party may be kept appraised of the situation via one or more messages, or by viewing a status report available through server 94.

In some instances, if the association of the calling party's ANI with the push ring tone at the called party's mobile phone occurs when the called party's mobile phone is configured not to play ring tones (e.g., if the phone is set to a silent, vibrate or other mode of operation in which it does not play ring tones), the called party may be informed of same via a similar type of return message (sent directly phone-to-phone or via the server 94). This may alert the calling party not to place a call to the called party at that time as the newly associated ring tone would not be played and/or the called party may not available to participate in a call at that time.

The application 92 may also be configured to report other occurrences or events connected with the pushing of a ring tone. For example, in some cases the called party's mobile phone may not have sufficient storage space to accommodate a new ring tone. In such a case, the application running on the called party's phone 84b may inform the server 94 of the situation and the server may then alert both the called party and the calling party of the situation, e.g., via an SMS or similar message. This may prompt the called party to delete other items from memory to make room for the new ring tone. Also, the calling party is alerted that the association of the new ring tone with the calling party's ANI did not take place and so the calling party would not expect the called party's phone to play the ring tone when the calling party calls. In other instances, the calling party (and, optionally the called party) may be alerted if the calling party tries to push a ring tone to a called party that has a mobile phone which is not supported by the service (e.g., a phone for which there is no usable version of application 92 or a phone that operates in a region where downloading of applications or ring tones, etc. is not permitted).

If at the time a ring tone is being pushed, or a called party's ANI is pushed for association with a previously stored ring tone, the called party's mobile phone 84b does not contain an address book entry for the calling party's ANI, application 92 may create such an entry s part of the ring tone—ANI association process. As part of this procedure, the server 94 may be queried by the application 92 for the calling party's name and, optionally, address for inclusion in the address book entry. In some cases, the server 94 may seek authorization from the calling party before releasing such information to the called party, or as part of the ring tone push process or the subscription terms and conditions, the calling party may be required to such release of information upon request by a putative recipient of a pushed ring tone initiated by that calling party.

In some instances, the called party's phone may be off-line for a period of time (e.g., while the called party is traveling on an airplane, etc.), and so a number of push ring tone invitations may be queued up. For example, multiple friends may have sent push ring tones to the called party such that when the called party's phone comes on-line a number of SMS messages inviting downloads of push ring tones are presented to the called party. Application 92 may be configured to download all such ring tones (and associate them with the respective ANIs) without the called party having to separately respond to each SMS message. For example, responding to one of the messages may be sufficient to initiate the download of all queued push ring tones (although the called party may be given the opportunity to separately reject those ring tones which he/she does not wish to receive). Alternatively, this facility may only be available if the two or more of the queued messages involve the same push ring tone, in which case it is downloaded and associated with the two or more different ANIs, and separate messages associated with different ring tones would have to be responded to separately.

Prior to initiating any push ring tones, the calling party may be required to register with the service. This may be done through a Web based application (e.g., hosted at server 94 or another resource) using mobile phone 84a or a personal computer. After registering, the calling party may be permitted to download and install application 92 on mobile phone 84a (e.g., in response to receipt of an SMS message with a link to obtain the application) or, in the case where the application is already resident on the mobile phone or a SIM card installed therein, the calling party may be provided with an activation code to unlock the application and begin using it or an activation message may be sent to the application from the server.

After registering, the calling party can invite the called party to join the service. As discussed above, this may involve having server 94 send an invitation to the called party (e.g., in an SMS or other message), and in response to accepting the invitation (e.g., by selecting a link in the SMS message) client 92 may be downloaded and installed onto (or activated if already installed) mobile phone 84b. Alternatively, accepting the invitation may prompt the server to send a second SMS message to mobile phone 84b, and this second SMS message may include the link to download application 92. Once the application is successfully installed, the application 92 may send a notification to that effect to the server 94 and/or to the calling party.

Among the various features available to subscribers of the push ring tone service is the ability to view a list of invited contacts and an indication of whether or not they have accepted the installation of the application 92 on their respective mobile phones. This list may be viewed on the calling party's mobile phone 84a, either through a web browser or through an appropriate interface provided by application 92. Alternatively, the list of invitees may be viewed using a personal computer and Web browser, when the user log in to his/her account with the service. The status of invited contacts may be “pending”, indicating the invitations have been sent, but not yet responded to, “accepted”, indicating that the invited party had downloaded a copy of an application 92, or “rejected”, indicating that the invited party had declined to download and install the application. If a calling party attempts to send an invitation to a called party that has already accepted an earlier invitation, the calling party is advised of same.

In addition, the service provides a user with the ability to create groups and assign ring tones to all of the members of a group. Contacts that have accepted invitations to download and install the application 92 on their mobile phones are eligible for assignment to a group and ring tones can be pushed to a group by specifying the group name or identifier and the desired ring tone. Server 94 then determines the individual members of the group and pushes the ring tone separately to each member in any of the manners discussed above.

Users are also able to designate “favorite” ring tones and have them populate a favorites list. This can provide a shortcut when the user seeks to push a ring tone to a friend inasmuch as the user may be able to make a quick selection from his/her favorites list during a call to server 94. In addition to favorites from a list of available ring tones, the user may be able to designate their own personally recorded voice messages or ring tones as well. Such messages or personal ring tones may be uploaded to server 94 via a web interface using a personal computer.

In some instances, where a called party has already accepted installation of the application 92, downloading of new ring tones from one or more “friends” may be done automatically. For example, a user may designate (either as part of a registration process or at another time), others from which the user is willing to accept pushed ring tones. Or, the user may agree to accept such ring tones as part of the service terms and conditions. In either event, ring tones may be pushed to the user's mobile phone through “silent” SMS messages. That is, friends of the users may designate ring tones to be pushed to the user's phone and the server 94 may push those tones using SMS messages which are automatically received by the application 92, which then downloads the associated ring tone from server 94 and associates it with the ANI of the party that caused the ring tone to be pushed. These silent SMS messages are not displayed to the user nor do they cause the mobile phone to announce the receipt of the message. Upon successful downloading of the ring tone, the application may so inform the server and the server may notify the party that pushed the ring tone of same.

Thus, systems and methods for allowing a calling party to specify a ring tone to be played by a called party's mobile phone handset have been described. Importantly, the embodiments described herein are intended to serve as non-limiting examples of the present invention.

What is claimed is:

1. A method, comprising at a server and in response to receipt of a called party's telephone number and identification of a ring tone to be pushed to a mobile phone handset associated with the called party telephone number, transmitting the ring tone and an ANI to be associated therewith to the called party telephone number in a format suitable for use by the mobile phone handset associated with the called party's telephone number.

2. The method of claim 1, wherein the ring tone to be pushed to the mobile phone handset associated with the called party's telephone number is selected by a calling party.

3. The method of claim 2, wherein the ANI to be associated with the ring tone pushed to the mobile phone handset associated with the called party's telephone number is an ANI associated with a mobile phone of the calling party.

4. The method of claim 2, wherein the calling party further selects a time and date for the ring tone to be pushed to the mobile phone handset associated with the called party's telephone number.

5. The method of claim 2, wherein the ring tone is pushed to multiple different mobile phone handsets at the direction of the calling party.

6. The method of claim 1, wherein prior to pushing the ring tone to the mobile phone handset associated with the called party's telephone number, an operating system-level application is installed on the mobile phone handset associated with the called party's telephone number, said application permitting association of a push ring tone with a calling party's ANI when a ringing signal is received.

7. The method of claim 6, wherein following installation of the application and ring tone on the mobile phone handset associated with the called party's telephone number, subsequent calls from a calling party's handset associated with the ANI that are placed directly to the mobile phone handset associated with the called party's telephone number trigger, based on the ANI, playing of the ring tone.

8. A method, comprising transmitting a ring tone and an ANI associated with a telephone number from which a call will be placed to a mobile phone number associated with a called party identified by a calling party; at a handset associated with the mobile phone number, associating the ring tone and the ANI; and, thereafter, placing the call to the mobile phone number so as to cause the handset associated with the mobile phone number to play the ring tone.

9. The method of claim 8, wherein the calling party identifies the mobile phone number associated with called party from a previously stored list.

10. The method of claim 8, wherein the calling party identifies the mobile phone number associated with called party during a call to an automated service.

11. The method of claim 8, wherein the calling party identifies the mobile phone number associated with called party by providing the mobile phone number during a call to an automated service and further selects the ring tone during the call to the automated service.

12. The method of claim 8, wherein prior to transmitting the ring tone and ANI, the called party is invited, via a text message, to have the handset associated with the mobile phone number receive the ring tone.

13. The method of claim 12, wherein the ring tone is transmitted after receipt of a response to the text message indicating agreement to receive the ring tone.

14. The method of claim 13, wherein the response is sent as a text message.

15. The method of claim 13, wherein the response is received at an interactive voice response system.

16. The method of claim 12 wherein following acceptance to receive the ring tone, an operating system-level application is downloaded and installed to the handset associated with the mobile phone number prior to transmitting the ring tone.

17. A method, comprising playing, at a mobile phone handset, a designated ring tone in response to receipt of a call from a calling party, said designated ring tone having been pushed to said mobile phone handset and installed thereon according to a sequence of computer-executable instructions stored on a SIM card used by said mobile phone handset, which instructions configure said mobile phone handset so that ring tones selected by a calling party can be triggered upon recognition of an ANI of the calling party or a USSD message.

18. A computer-readable storage medium having stored thereon computer-readable instructions, which instructions, when executed by a processor, cause said processor to perform a method, comprising playing, on a mobile phone handset, a designated ring tone in response to receipt of a call from a calling party, said designated ring tone having been installed on said mobile phone handset according to a sequence of said computer-executable instructions stored on the computer readable storage medium responsive to an invitation to download the designated ring tone and associate the designate ring tone with an ANI of the calling party or a USSD message.

19. A method comprising contacting, using a first mobile phone, a server and specifying a ring tone to be pushed to a second mobile phone, the server inviting a user of the second mobile phone to download and install an instance of an operating system-level application, and after installation of said instance of said application, the server pushing the ring tone to the second mobile phone and the ring tone being saved at the second mobile phone so that it is associated with the ANI of the first mobile phone.

20. The method of claim 19, further comprising, advising the first mobile phone of circumstances associated with installation of the instance of the application at the second mobile phone.

21. The method of claim 20, wherein in the event receipt or installation of the ring tone at the second mobile phone is interrupted before completion, automatically reinitiating downloading and installation of the ring tone by the second mobile phone.

22. The method of claim 19, wherein if the second mobile phone is set to a mode which precludes playing of a ring tone when the ring tone is saved, sending a message to the first mobile phone advising of this circumstance.

23. The method of claim 19, wherein if the second mobile phone has insufficient memory to store the ring tone, then prior to pushing the ring tone to the second mobile phone, sending messages to at least one of the first mobile phone or the second mobile phone advising of this circumstance.

24. The method of claim 19, further comprising creating an address book entry for the ANI of the first mobile phone at the second mobile phone.

25. The method of claim 19, wherein pushing the ring tone to the second mobile phone is responsive to selection of a link in a message different from that inviting the user of the second mobile phone to download and install the instance of the application.
